(19) United States
(12) Patent Application Publication
(10) Pub. No.: US 2002/0064259 A1
(43) Pub. Date: May 30, 2002

(54) Portable sub-service station

(76) Inventor: Wen-Sung Tsai, Taipei (TW)

Correspondence Address: NAIPO (NORTH AMERICA INTERNATIONAL PATENT OFFICE), P.O. BOX 506, MERRIFIELD, VA, 22116, US

(21) Appl. No.: 09/725,029

(22) Filed: Nov. 29, 2000

(51) Int. Cl. H04M 11/00

(52) U.S. Cl. 379/106.01; 379/90.01

(57) ABSTRACT

A portable sub-service station for a servicing system provides diagnostic and servicing support for an electric device. The servicing system has a service center for providing diagnostic and servicing support, and a communications link that enables communications between the service center and the sub-service station. The sub-service center has a processor, a communications module for establishing communications with the service center via the communications link, memory for the processor, a control program stored in the memory, an input/output (I/O) port for receiving signals from the electric device and for sending signals to the electric device, a display for presenting visual information to a user, and an input panel that enables the user to provide input to control the operations of the sub-service station. The electric device is detachably electrically connected to the I/O port of the sub-service station, and the sub-service station performs diagnostic or servicing functions on the electric device. The display informs the user of the status of the servicing or diagnostic functions. The service station optionally communicates with the sub-service station to facilitate the diagnostic and servicing functions.

### BACKGROUND OF THE INVENTION

1. Field of the Invention

The present invention relates to diagnostic equipment. More specifically, the present invention discloses a sub-service station that can work in conjunction with a main service center via a communications network to perform servicing and diagnostic functions for a specific device.

2. Description of the Prior Art

The deep market penetration of sophisticated electronic devices has created an unfortunate side effect in that the operation of these devices is often too complicated for the typical user to understand. Determining if a device is faulty, or simply setup incorrectly, can seem like a Herculean task for those whose who are not “technologically savvy”. Personal computers, for example, are notoriously difficult for the average user to properly configure. The solution to this problem has been the creation of user-support centers by the manufacturers of the devices. These centers rely on dialogue between the user and a technician to troubleshoot the devices, usually by way of a toll-free phone call on the part of the user. Such centers, however, are often overwhelmed by a flood of calls spread over an insufficient number of technicians. This leads to calls placed on hold for long periods of time, and customer dissatisfaction. Additionally, customers can be confused by, or incorrectly perform, troubleshooting instructions requested by the technician. This leads to delays, which in turn reduce customer throughput and increase telephone expenses.

### SUMMARY OF THE INVENTION

It is therefore a primary objective of this invention to provide a portable sub-service station that can be attached to a device by the user to perform diagnostic and servicing functions.

The present invention, briefly summarized, discloses a portable sub-service station for a servicing system, which provides diagnostic and servicing support for an electric device. The servicing system has a service center for providing diagnostic and servicing support, and a communications link that enables communications between the service center and the sub-service station. The sub-service center has a processor, a communications module for establishing communications with the service center via the communications link, memory for the processor, a control program stored in the memory, an input/output (I/O) port for receiving signals from the electric device and for sending signals to the electric device, a display for presenting visual information to a user, and an input panel that enables the user to provide input to control the operations of the sub-service station. The electric device is detachably electrically connected to the I/O port of the sub-service station, and the sub-service station performs diagnostic or servicing functions on the electric device. The display informs the user of the status of the servicing or diagnostic functions. The service station optionally communicates with the sub-service station to facilitate the diagnostic and servicing functions.

It is an advantage of the present invention that servicing and troubleshooting of an electric device is automated by the sub-service station. The sub-service station can download appropriate software from the service center so that it may autonomously perform the servicing or diagnostic functions. Alternatively, the sub-service station may be controlled by the service center via the communications link to perform the servicing or diagnostic functions. In either case, the user is relieved of the more technical manipulations of the device, and the entire servicing procedure is speeded up.

These and other objectives of the present invention will no doubt become obvious to those of ordinary skill in the art after reading the following detailed description of the preferred embodiment, which is illustrated in the various figures and drawings.

### BRIEF DESCRIPTION OF THE DRAWINGS

FIG. 1 is a diagram of a servicing system according to the present invention.

FIG. 2 is a diagram of a portable sub-service station according to the present invention.

FIG. 3 is a block diagram of the sub-service station of FIG. 2.

FIG. 4 illustrates a device to be serviced by a servicing system of the present invention.

### DETAILED DESCRIPTION OF THE PREFERRED EMBODIMENT

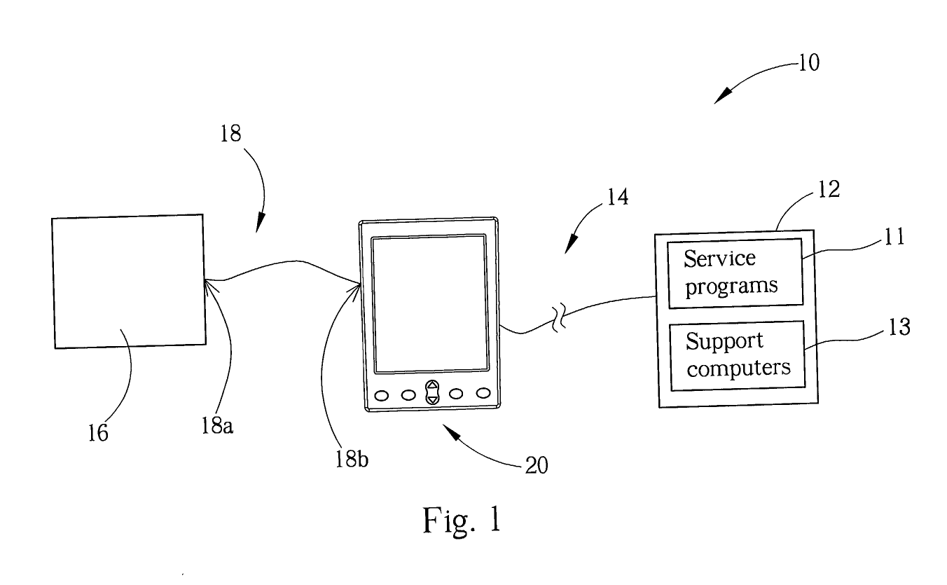

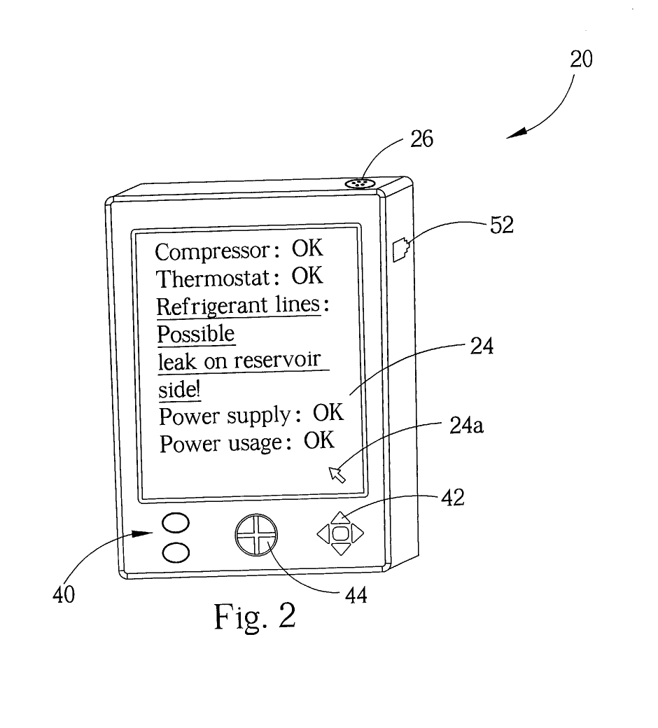

Please refer to FIG. 1 and FIG. 2. FIG. 1 is a diagram of a servicing system 10 according to the present invention. FIG. 2 is a diagram of a portable sub-service station 20 according to the present invention. The servicing system 10 comprises a service center 12, a communications link 14, a device 16 that is to be checked, the portable sub-service station 20 and a cable 18 that detachably connects the sub-service station 20 to the device 16. The servicing system 10 is used to perform servicing or diagnostic support of the device 16. For example, the servicing system 10 may be used to perform a software upgrade of any software within the device 16. Alternatively, if the device 16 appears to a user to be malfunctioning, the servicing system 10 is used to perform diagnostic checks or corrections of the device 16.

The service center 12 acts a repository and support for the servicing system 10. The service center 12 may hold a plurality of service programs 11 or support computers 13. Each service program 11 is written for a particular type of device 16 for use by the sub-service station 20. Depending on the type of device 16 to which it is connected, the sub-service station 20 uses the communications link 14 to download an appropriate service program 11. This service program 11 is then executed by the sub-service station 20 to perform servicing or diagnostic functions. Alternatively, the sub-service station 20 can act as a go-between for the device 16 and the support computers 13 of the service center 12. That is, the support computers 13 use the sub-service station 20 as a node in the communications link 14 to perform servicing or diagnostic support of the device 16.

As noted above, the communications link 14 is used by both the sub-service station 20 and the service center 12 to effect communications between the two. For example, the communications link 14 is used to download any required service programs 11 to the sub-service station 20. Similarly, the sub-service station 20 uses the communications link 14 to upload diagnostic information to the support computers 13, and the support computers 13 send diagnostic control commands to the sub-service station 20 by way of the communications link 14. The communications link 14 could be any suitable means of communication for devices, such as a telephone network, the Internet, or even radio communications. In the present embodiment, it is envisioned that a standard telephone network be used due to the wide availability of such communications systems, and cost-effectiveness.

The device 16 could be any sort of electric device that has been configured to interface with the sub-service station 20, or which has contacts that can be monitored by the sub-service station 20. For example, the device 16 could be a computer, a computer peripheral such as a scanner or a printer, audio or video equipment, or even the electronic system of an automobile. The range of possible devices 16 that need technical support is huge, and cannot be exhaustively listed here. Although it would be beneficial that the device 16 have its own internal hardware and associated software to interface with and support the sub-service station 20, such equipment is not absolutely necessary. As noted above, it may also be possible for the sub-service station 20 to connect to certain portions of the device 16, and monitor the activity therein, to perform a diagnostic or servicing routine. Indeed, the user could be instructed by the sub-service station 20 to connect to various regions of the device 16 during the course of a diagnostic or servicing routine to inspect or alter various different aspects of the device 16.

The cable 18 is used to electrically connect the sub-service station 20 to the device 16. The cable can be attached and detached from either the sub-service station 20 or the device 16. The device end 18a of the cable 18 could have a connector that is device-specific, or could be an adapter that is connected to the cable 18 to interface with the device 16. Alternatively, the device end 18a could simply be a standard interface, such as an RS-232 serial interface, a parallel interface, a universal serial bus (USB) interface, etc. Similarly, the end 18b of the cable 18 may have a proprietary design for interfacing with the sub-service station 20, or it may use a standard interface design. Note that, with the proliferation of wireless computing standards, such as the Bluetooth standard, the cable 18 may not be needed at all, and could be replaced by such a wireless communications channel.

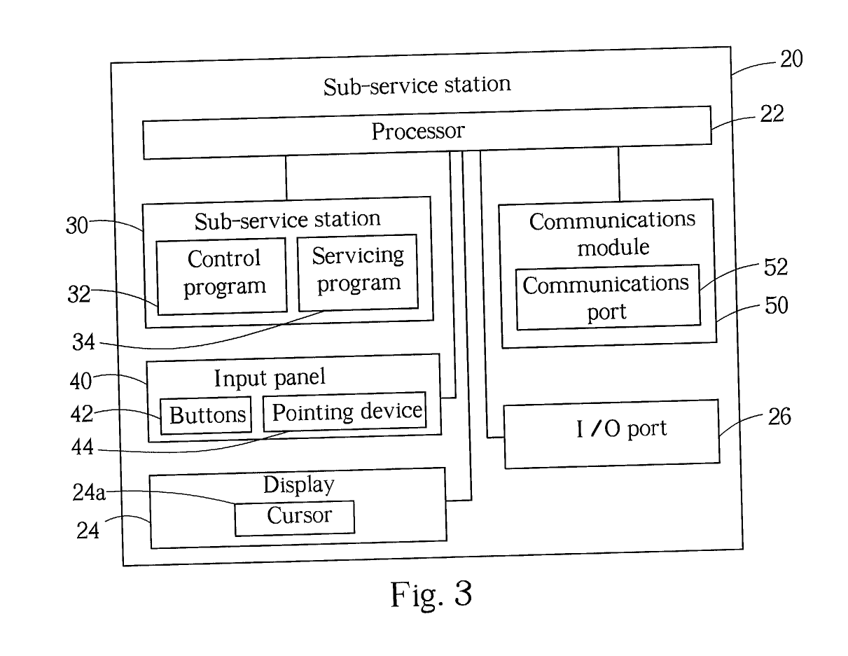

Finally, of particular importance to this invention, is the sub-service station 20. The sub-service station 20 is a portable device so that the sub-service station 20 may be easily carried by a user to the device 16. This is necessary as some devices may be quite heavy or bulky, and so would not easily avail themselves to being brought to the sub-service station 20. The sub-service station 20 may be a custom built device designed and manufactured by one suitably skilled in the art, or it may be a commercially available device, such as a portable computer or a personal data assistant (PDA). Please refer to FIG. 3 in conjunction with FIGS. 1 and 2. FIG. 3 is a block diagram of the sub-service station 20. The sub-service station 20 comprises a processor 22 that controls the operations of the sub-service station 20, a memory 30, an input panel 40, a display 24, a communications module 50 and an input/output (I/O) port 26. The memory 30, input panel 40, display 24, communications module 50 and I/O port 26 are all electrically connected to the processor 22.

The input panel 40 enables the user to provide input to the sub-service station 20, and comprises buttons 42 and a pointing device 44. The buttons 44 can be pressed by the user to respond to queries from the sub-service station 20, or to control the operations of the sub-service station 20. The pointing device 44 is used to control the position of a cursor 24a on the display 24. The pointing device 44 could be a trackball, a touch-pad, or a bi-directional rocker switch. The cursor 24a is also used as in input device to select certain options shown on the display 24.

The display 24 is a liquid crystal display (LCD), and may be either monochrome or color. It may also be a touch-sensitive display, as is the case for most PDA devices, and as such can also serve as an input device. That is, if the display 24 is a touch-sensitive display, then some of the buttons 42 of the input panel 40 can be shifted graphically onto the display 24. Similarly, the pointing device 44 would no longer be necessary if the display 24 is touch-sensitive. The display 24 is used to present visual information to the user in the form of graphics or text. The display 24 can present to the user the status of a diagnostic or servicing routine, and prompt the user to perform a function (such as attaching or repositioning the cable 18) or answer a question (such as, “Is the device still faulty?”).

The I/O port 26 is used to send signals to the device 16, or to receive signals from the device 16. As noted above, the cable 18 can be attached and detached from the I/O port 16, and the I/O port 16 could have a proprietary design, or a standard design. Also, as noted before, for some devices, a physical I/O port 26 may not even be necessary as radio communications could instead be used.

The communications module 50 is used to establish communications with the service center 12 by way of the communications link 14. The communications module 50 includes a communication port 52. The communications port 52 is of a standard design according to the communications method used. For example, the communications port 52 could be an Ethernet port to connect to an Ethernet cable for networking communications (i.e., the Internet). Alternatively, the communications port 52 could be an RJ-11 port for establishing telephonic communications through a telephone line (i.e., a modem connection). As explained previously, the preferred embodiment envisions the use of a telephone socket, and the communications module would then include a modem, so that the sub-service station 20 connects to the service center 12 by way of a telephone network. Note that other methods of communication are possible. For example, the communications module 50 could be a Bluetooth module that is in radio communications with a server (not shown). This server could then be used to connect with the service center 12 by way of the Internet or a telephone connection.

The memory 30 comprises a control program 32 and, optionally, a servicing program 34. The control program 32 is executed by the processor 22 and is used to control the various operations of the sub-service center 20, such as interfacing with the service center 12. If the sub-service center 20 is a PDA or a portable computer, then the control program 32 would be an application program that runs under the operating system of the PDA or the portable computer. Alternatively, the control program 32 could be permanently stored in read-only-memory (ROM) and serve as the program in overall control of the sub-service station 20, acting as an operating system. The servicing program 34 is optionally downloaded by the user from the service center 12, and is one of the device-specific service programs 11. The control program 32 assists the user in downloading and installing the servicing program 34, and uses the communications module 50 and communications link 14 to perform the download. When executed by the processor 22, the servicing program 34 has all of the data and functional steps needed to allow the sub-service station 20 to autonomously service or diagnose the device 16 without requiring any additional help from the service center 12.

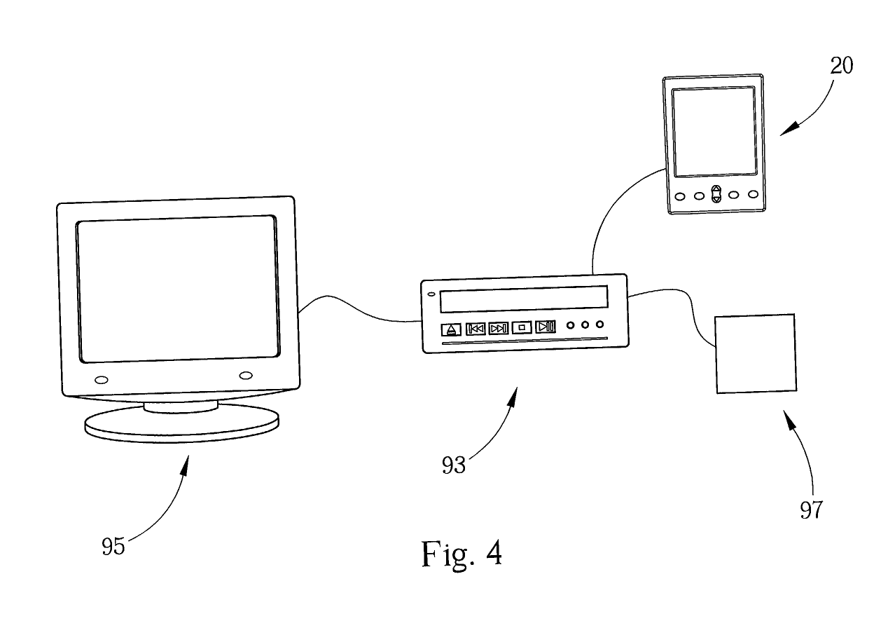

To better understand the operations of the servicing system 10, a simple example is given below. This example is meant to be illustrative only, and does not limit the scope of this invention. Please refer to FIG. 4 in conjunction with FIG. 1 and FIG. 3. FIG. 4 illustrates a device to be serviced by the servicing system 10 of the present invention. Imagine, for example, that a user has a particularly complicated video recorder 93, and is unable to get this video recorder 93 to record at a desired time. The video recorder 93 is connected to a signaling system 97, either a cable provider or an antenna, from which it receives video signals. These video signals can be recorded by the video recorder 93, as well as passed on to a television 95 for viewing by the user. To perform the diagnostic function of the video recorder 93, two methods of operation are possible: (1) The sub-service station 20 acts as an intermediary for the support computers 13 in the service center 12, or (2) An appropriate service program 11 is downloaded from the service center 12 to the sub-service station 20, which is then executed as a servicing program 34 that autonomously performs the diagnostic function.

For the first case, the sub-service station 20 is connected to the communications link 18 to establish communications with the service center 12. For example, a telephone jack is plugged into the communications port 52. The sub-service station 20 uses the communications module 50 to dial up an appropriate number and establish a modem connection with the service center 12. The control program 32 then interfaces with at least one of the support computers 13 of the service center 12, receiving commands from the support computer 13, and sending diagnostic data and user input to the support computers 13. The support computer 13 can instruct the control program 32 to present information on the display to direct and prompt the user. For example, the support computer 13 may first instruct the control program 32 to present a list of different video recorders, asking the user to select a model that corresponds to the video recorder 93. By use of the input panel 40, the user can make a selection, and the control program 32 then sends this selection to the support computer 13. The support computer 13 may then instruct the user to connect the sub-service station 20 to the video recorder 93, and then the diagnostic process can begin. Diagnostic and service data received by the sub-service station 20 from the video recorder 93 is passed on to the support computer 13 by way of the communications link 14. After various prompts from the support computer 13 via the control program 32, the support computer 13 can begin the process of testing the video recorder 93, and programming the video recorder 93 to begin recording at the time desired by the user. Exactly how these steps may be performed is not of direct relevance to this invention. What is important is that it is, finally, the support computer 13 in the service center 12 that is in control of the servicing and diagnostic functions, using the control program 32 as an interface to control the operations of the sub-service station 20.

Alternatively, with the second method of operation, a constant communications link 14 is not required. If the servicing program 34 for the video recorder 93 is already present in the sub-service station 20, then it can be executed by the processor 22 to perform the troubleshooting functions. The servicing program 34 simply takes the functionality offered by the support computers 13 and downloads it directly to the sub-service station 20. That is, from the standpoint of the user, there would be little or no difference between the first operating method and the second, apart from the fact that no persistent communications link 14 is required in the second method. The servicing program 34 prompts the user to perform any required tasks, such as connecting the sub-service station 20 to the video recorder 93, and performs the diagnostic and servicing functions. In this case, the servicing program 34 might download basic diagnostic data from the video recorder 93 to insure that the video recorder 93 is, in fact, in satisfactory operating condition, and then prompt the user for a desired recording time, before programming the video recorder 93. The servicing program 34, tailored for the specific device, i.e., the specific model of the video recorder 93, offers the user all of the support offered by the support computers 13. Once it has finished executing, the servicing program 34 may optionally decide to remove itself from the memory 30 of the sub-service station 20.

If the appropriate servicing program 34 is not available on the sub-service station 20, then it can be downloaded from the service center 12 by way of the control program 32 and the communications link 14. That is, the communications link 14 with the service center 12 is established just as it is in the first method, but then, instead of performing a diagnostic function, an appropriate service program 11 is downloaded. This service program 11 becomes the servicing program 34 within the sub-service station 20. The communications link 14 can then be terminated, and the new servicing program 34 is executed to perform the servicing and diagnostic functions of the video recorder 93.

In contrast to the prior art, the present invention provides a sub-service station that electrically connects to a device to be serviced. The sub-service station obtains support from computers in a service center by way of a communications link. The sub-service station may either act as an intermediary between the computers of the service center, or it may download a servicing program from the service center to autonomously perform the servicing function on the device.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A servicing system for an electric device, the servicing system comprising:
a portable sub-service station electrically connected to the electric device, the sub-service station performing diagnostic or servicing functions on the electric device;
a service center; and
a communications link enabling communications between the service center and the sub-service station;
wherein the sub-service station obtains diagnostic and servicing support for the electric device from the service center via the communications link.

2. The servicing system of claim 1 wherein the sub-service station is detachably connected to the electric device.

3. The servicing system of claim 2 wherein the sub-service station comprises:
a processor for controlling the operations of the sub-service station;
a communications module for establishing communications with the service center via the communications link;
a memory for the processor;
a control program stored in the memory and executed by the processor for controlling the operations of the processor;
an input/output (I/O) port for receiving signals from the electric device or for sending signals to the electric device; and
a display for presenting visual information to a user;
wherein the electric device is detachably electrically connected to the I/O port of the sub-service station, and the display is used to inform the user of the status of the servicing or diagnostic functions.

4. The servicing system of claim 3 wherein the service center interfaces with the control program via the communications link to control the operations of the sub-service station.

5. The servicing system of claim 3 wherein the sub-service station further comprises a servicing program stored in the memory for performing the servicing or diagnostic functions, the servicing program executed by the processor, so that the sub-service station performs the servicing or diagnostic functions autonomously of the service center.

6. The servicing system of claim 5 wherein the sub-service station downloads the servicing program from the service center via the communications link.

7. The servicing system of claim 6 wherein the servicing program is designed for the electric device.

8. The servicing system of claim 4 wherein the sub-service station further comprises an input panel that enables the user to provide input to control the operations of the sub-service station.

9. The servicing system of claim 5 wherein the sub-service station further comprises an input panel that enables the user to provide input to control the operations of the sub-service station.

10. The servicing system of claim 8 wherein the sub-service station is a portable computer or a personal data assistant (PDA).

11. The servicing system of claim 9 wherein the sub-service station is a portable computer or a personal data assistant (PDA).

12. The servicing system of claim 1 wherein the communications link is effected through the Internet or through a telephone network.

13. A portable sub-service station for a servicing system, the servicing system comprising:
a service center for providing diagnostic and servicing support of an electric device; and
a communications link enabling communications between the service center and the sub-service station;
the sub-service center comprising:
a processor for controlling the operations of the sub-service station;
a communications module for establishing communications with the service center via the communications link;
a memory for the processor;
a control program stored in the memory and executed by the processor for controlling the operations of the processor;
an input/output (I/O) port for receiving signals from the electric device or for sending signals to the electric device;
a display for presenting visual information to a user; and
an input panel that enables the user to provide input to control the operations of the sub-service station;
wherein the electric device is detachably electrically connected to the I/O port of the sub-service station, the sub-service station performs diagnostic or servicing functions on the electric device, and the display is used to inform the user of the status of the servicing or diagnostic functions.

14. The servicing system of claim 13 wherein the service center interfaces with the control program via the communications link to control the operations of the sub-service station.

15. The servicing system of claim 13 wherein the sub-service station further comprises a servicing program stored in the memory for performing the servicing or diagnostic functions, the servicing program executed by the processor, so that the sub-service station performs the servicing or diagnostic functions autonomously of the service center.

16. The servicing system of claim 15 wherein the sub-service station downloads the servicing program from the service center via the communications link.

17. The servicing system of claim 16 wherein the servicing program is designed for the electric device.

18. The servicing system of claim 14 wherein the sub-service station is a portable computer or a personal data assistant (PDA).

19. The servicing system of claim 15 wherein the sub-service station is a portable computer or a personal data assistant (PDA).

20. The servicing system of claim 13 wherein the communications link is effected through the Internet or through a telephone network.
